(19) United States
(12) Patent Application Publication
(10) Pub. No.: US 2017/0178257 A1
(43) Pub. Date: Jun. 22, 2017

(54) SERVICE STATION FUEL PUMP

(71) Applicants: Wal-Mart Stores, Inc., Bentonville, AR (US); Wal-Mart Stores, Inc., Bentonville, AR (US)

(72) Inventors: Jeremy Tingler, Bentonville, AR (US); Alvin Scott Taulbee, Springdale, AR (US); Kenneth Dewayne Clark, Bella Vista, AR (US)

(21) Appl. No.: 15/381,048

(22) Filed: Dec. 15, 2016

Related U.S. Application Data
(60) Provisional application No. 62/269,891, filed on Dec. 18, 2015.

(51) Int. Cl. G06Q 50/06; G06K 19/077; G06Q 20/40; G06Q 20/18; G06Q 40/00; G06Q 20/32; G06K 7/10; G06Q 20/20

(52) U.S. Cl. CPC G06Q 50/06; G06K 7/10198; G06K 19/07758; G06Q 20/202; G06Q 20/18; G06Q 40/12; G06Q 20/3278; G06Q 20/405; G06K 7/1417

(57) ABSTRACT

Methodologies, systems, and computer-readable media are provided for generating fuel authorization commands. An electronic scanning device can receive identification data corresponding to a user, and a server can associate the identification information with a user's account. The server can retrieve customized data indicating a specified monetary value of fuel to be purchased by the user. The user can access the account and set a desired monetary value and other customized automotive data. The server can request authorization of the specified monetary value and, if authorization is received, generate and transmit a fuel authorization command to a service station fuel pump to allow the user to dispense fuel.

### RELATED APPLICATIONS

This application claims priority to U.S. Provisional Patent Application Ser. No. 62/269,891 entitled “SYSTEMS, DEVICES, AND METHODS FOR AUTOMATICALLY CONTROLLING AUTOMOTIVE FUEL AND SERVICE STATIONS,” filed on Dec. 18, 2015, the content of which is hereby incorporated by reference in its entirety.

### BACKGROUND OF THE TECHNOLOGY

In general, individuals wishing to purchase fuel for a motor vehicle frequently do so at a filling station using a charge card linked to a financial account at the time of purchase. The transaction authorization process causes a temporary hold to be placed on the user's account corresponding to a generic pre-authorization amount. For example, a common hold amount is $75 in response to swiping a credit (or debit) card at the pump regardless of the amount the user intends to purchase. Additionally, if a user wishes to purchase more fuel than the generic pre-authorized amount, a second transaction is required.

### SUMMARY

Exemplary embodiments of the present invention provide systems, devices, and methods for generating customized fuel authorization commands.

In accordance with some examples of the present invention, a system for generating customized fuel authorization commands based on customized user data in response to receiving identification data from an external electronic device is disclosed. The system includes a service station fuel pump configured to dispense fuel to a user. The system also includes an electronic scanning device in communication with the service station fuel pump and configured to receive identification data from an electronic device associated with the user. The system also includes a server in communication with the service station fuel pump. The server is configured to access an account associated with the identification data, the account including customized data indicating a specified monetary value of fuel to be purchased by the user. The server is also configured to request and receive authorization of the specified monetary value. The server is also configured to generate a fuel authorization command for the service station fuel pump to initiate dispensing of fuel from the service station fuel pump for an amount of fuel that has a monetary value corresponding to the received authorization.

Additional combinations or permutations of the above examples are envisioned as being within the scope of the present invention. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method of generating customized fuel authorization commands, according to an embodiment of the present invention.

FIG. 2 is a flowchart illustrating another exemplary method of generating customized fuel authorization commands for an enterprise controlling service station fuel pumps, according to an embodiment of the present invention.

FIG. 3 is a flowchart illustrating an exemplary method of generating customized automotive work orders, according to an embodiment of the present invention.

FIG. 4 is a flowchart illustrating another exemplary method of generating customized automotive work orders, according to an embodiment of the present invention.

FIG. 5 is a diagram of an exemplary network environment suitable for a distributed implementation of an exemplary embodiment of the present invention.

FIG. 6 is a block diagram of an exemplary computing device that can be used to perform exemplary processes in accordance with an exemplary embodiment of the present invention.

### DETAILED DESCRIPTION

Following below are more detailed descriptions of various concepts related to, and embodiments of, inventive methods, apparatus, and systems for generating customized fuel authorization commands and automatically generating automotive work orders. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Example methodologies, systems, apparatus, and non-transitory computer-readable media are described herein to facilitate generating customized fuel authorization commands and customized automotive work orders.

Embodiments directed to customized fuel authorization commands address issues occurring in conventional fuel authorization techniques. For example, purchasing fuel or automotive services can be cumbersome in regards to making payment, getting a receipt, selecting a fuel type or fuel grade, and receiving payment pre-authorization. Mistakes in fuel choice or grade (e.g. diesel vs. gasoline vs. E85) can damage a user's vehicle. Most fuel stations now require pre-paying for fuel, which requires a user to either pay at the pump or travel into the station to pay before fueling. Often a pre-authorization amount at the pump places a relatively large hold on an account, which is often held back from the customer's available balance. Portions of the hold that are not used in the subsequent transaction may nevertheless take several hours to be released, thereby depriving a user of the use of otherwise available funds. Further, because the fuel dispensed may not exceed the pre-authorized amount, vehicles with large fuel tanks may be required to engage in multiple transactions when paying at the pump. When prepaying inside, a user must guess the amount to prepay and either not buy enough fuel or go back inside the store to receive a refund. Often the receipt printer at the pump is out of paper or out of service, additionally complicating the process of getting a receipt. There is also a generalized fear of data theft though pen-pad/card skimming when submitting payment at the pump. Fuel and automotive services providers also have a limited ability to market other automotive services to customers or inform customers of their vehicle's mileage, diagnostic trouble codes, etc. once they leave the fuel station.

In one embodiment, customized fuel authorization commands are automatically generated a based on customized user data. A service station fuel pump, such as a fuel point of sale terminal, may be equipped with an electronic scanning device that can receive identification information from an electronic device associated with a user or a user's vehicle. In exemplary embodiments, the electronic device may include, or be, an RFID tag or device on a vehicle, or a card containing such a tag. In some examples, the electronic scanning device may include an IR reader, wireless access point, RFID reader, magnetic card reader, QR code reader, biometric scanner, NFC detector, Bluetooth detector, low energy Bluetooth detector, wand scanner, integrated-circuit chip reader, geolocation device, or any other suitable user-machine interface device regardless of mobility or form factor. An identifier provided by the electronic device may be linked to a customer's account which may contain customized data relating to the user's preferred fuel type or grade, fuel purchase history, pre-authorization preference amount, receipt delivery options, payment preferences, payment authorization options, fuel additive or car wash intervals, vehicle service history, vehicle service schedule, vehicle service preferences, vehicle identification data, vehicle specifications, etc. Once the user's identification data has been associated with the user's account, the system can request pre-authorization for a monetary value specified in the account, or calculate a pre-authorization amount based on the user's fuel purchase history. Customers working within tight budgets may set a lower pre-authorization amount to avoid unduly large holds on the account. Conversely customers with large fuel tanks may set a much higher amount in order to avoid being forced to engage in multiple transactions to ensure a full tank. Having the ability to set their pre-authorization limit higher or lower, or automatically adjust their pre-authorization limit based on prior purchase or vehicle service data can increase consumer satisfaction.

In an exemplary embodiment, the specified monetary value, or pre-authorization limit, can be computed based on, for example, a specified monetary value input by the user via an electronic device or a budget that can be managed by the individual. Once the pre-authorized limit is computed, the individual's account number or other payment information may be used to set aside the pre-authorized amount for this particular transaction. In alternative embodiments, the user's fuel purchase history or vehicle service history can be used to calculate the pre-authorization limit. In still other embodiments, statistical data corresponding to other customers within the individual's demographic, statistical data corresponding to customers within a particular geographical region, or a default value may be used to calculate the pre-authorization limit. In exemplary embodiments, the system requests pre-authorization for the specified monetary value from a financial institution or financial account associated with the at least one individual. If the value is authorized, the system generates a fuel authorization command authorizing the service station fuel pump to dispense the amount of fuel corresponding to the specified monetary value. The actual amount of fuel dispensed can be any amount of fuel whose corresponding value that does not exceed the specified monetary value.

Once the vehicle arrives at the pump and a successful read of the tag occurs, all the customer's default options are accessed at the server using the identification data. The user's previously specified options a retrieved and transmitted to the fuel pump. Dispensing is authorized at the pump based on the pre-authorized monetary value indicated in the user's account. In further embodiments, if the user has several vehicles linked to a single account, the user may be given a choice of their linked vehicles, using a terminal at the service station or a mobile electronic device. After purchase the default options for receipt delivery would print a receipt, email a receipt, push the receipt to a mobile device, etc. based on the user's receipt preferences. A receipt or report of the transaction may then be stored on the customer's account purchase history. The system may also record a history of the user's visits and purchase history in order to market other automotive services, such as oil changes, regular vehicle maintenance, fluid washes, tire rotations, brake services, etc. According to certain embodiments, the customer can choose to change the preloaded options for one particular visit or all future visits to aid in the management of their account. Once reaching the customers pre-authorized amount, the customer can be given the option to authorize an additional amount if additional fuel is needed. In one embodiment, a series of automatic processes and algorithms can be used to automatically adjust the pre-authorization amounts for a user based on previous visits and/or the increasing/decreasing price of fuel. A user may also be able to link a bank account with their user account in order to provide direct payment for fuel and services thus saving the fuel vendor charges associated with processing credit card transactions. Some of these savings may be passed on to the user in the form of a reduced price or other manner to incentivize the user to link the user account with a bank account for payment. In some embodiments, a card may be used for pre-authorization, but a final payment may be made through an electronic check. Customized vehicle data, fuel purchase history, and vehicle service history may also allow an enterprise to propose additional automotive services to users, remind users when their vehicle may be low on fuel, or remind users of suggested vehicle maintenance. Such reminders or proposals may be based on the user's number of visits to a service station, a dollar amount spent in a specific period of time on automotive services or fuel, fuel purchase history, or vehicle service history.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

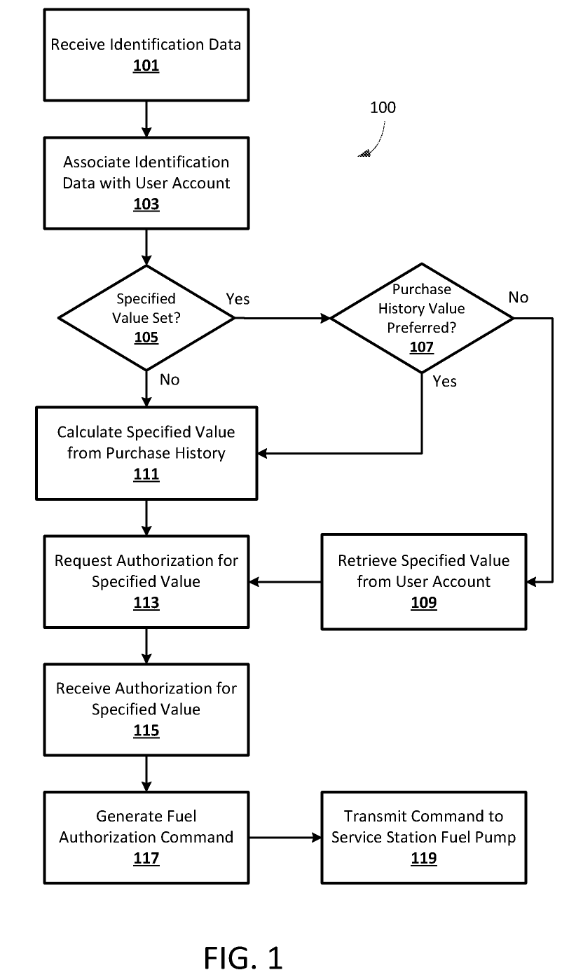

FIG. 1 is a flowchart illustrating an exemplary method 100 for generating customized fuel authorization commands, according to an embodiment of the present invention. It will be appreciated that the method is programmatically performed by one or more computer-executable processes executing on, or in communication with the server described further below. In step 101, a server receives identification data forwarded from a service station fuel pump. An electronic scanning device in communication with a service station fuel pump receives identification data from an electronic device associated with the user. The service station fuel pump can include, for example, a payment terminal or kiosk associated with a fuel pump or filling station. As discussed above, the electronic scanning device may include an IR reader, wireless access point, RFID reader, magnetic card reader, QR code reader, biometric scanner, NFC detector, Bluetooth detector, low energy Bluetooth detector, wand scanner, integrated-circuit chip reader, geolocation device, or any other suitable user-machine interface device regardless of mobility or form factor. In exemplary embodiments, a user may sign up for an account and be issued a unique RFID tag or other device containing identification data relating to the user's account. The user could affix the tag to their vehicle diagnostic port, carry it on their person, or carry it loosely in their vehicle. Alternatively, such a tag can be installed by a vehicle manufacturer or assembler. If the RFID tag/device is affixed to the customer's vehicle or included from an assembler or manufacturer, it can become a universal vehicle identification method.

In step 103, the identification data that was received by the server is associated/matched with the corresponding user's account. The user's account may include customized data indicating a specified monetary value of fuel to be purchased by the user. In some embodiments, the user's account may also include customized data relating to the user's preferred fuel type or grade, fuel purchase history, receipt delivery options, payment preferences, payment authorization options, fuel additive or car wash intervals, vehicle service history, vehicle service schedule, vehicle service preferences, vehicle identification data, vehicle specifications, vehicle mileage, etc.

In step 105, if the user's account includes a specified monetary value for fuel purchases, the method determines whether the user's prior purchase history is preferred for determining the specified value in step 107. If the user's fuel purchase history is the preferred method for calculating the pre-authorization limit, the method proceeds, or if no specified value is set by the user in step 105, the method continues with calculating a specified value from the user's prior purchase history in step 111. In exemplary embodiments, the specified value is calculated based on an average of the user's previous fuel purchases, or some other historical purchase pattern. In one example embodiment, an additional offset amount is added to the average purchase amount as a buffer in order to ensure approval. In such examples, the additional offset amount could be a percentage or a unit-based buffer amount, or it could be calculated based on current fuel prices, the size of the user's fuel tank, etc. It will be appreciated that the calculation may be performed in a number of different ways such as calculating an average of past purchases or calculating an average of the past purchases and adding 10% or some other amount to determine an authorized value. If, however, the user's account sets a specified monetary value, and the purchase history is not the preferred method for calculating the specified value, the method continues with retrieving the specified monetary value from the user's account in step 109.

Once the specified value is either retrieved or calculated, an authorization of the specified value is requested in step 113. In step 115, an authorization is received for the specified monetary value from a financial institution or financial account associated with the user (assuming of course that the user has sufficient funds in the account). In step 117, a fuel authorization command is generated to initiate dispensing of fuel from the service station fuel pump for an amount of fuel that has a monetary value corresponding to the received authorization. In additional embodiments, the system may further suggest, via a display screen printout, or other technique at the service station fuel pump, the purchasing of additional services, such as a car wash or oil change, based on the user's preferences, vehicle mileage, vehicle service history, etc. For example, a car wash or fuel additive service can be proposed or scheduled every time a user refuels a vehicle, or every “x” number of times a user visits a service station. The generated command is transmitted to the service station fuel pump in step 119.

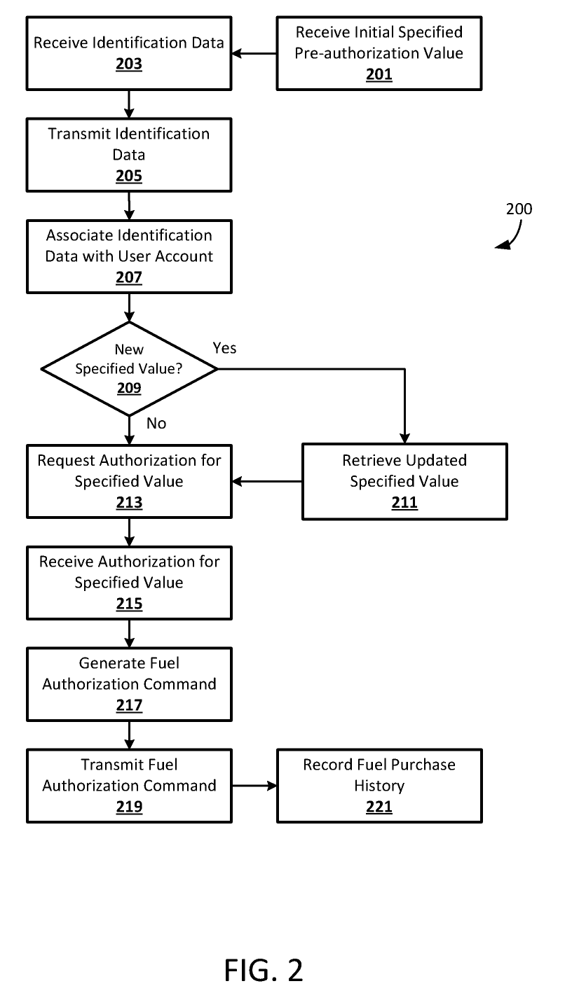

FIG. 2 is a flowchart illustrating another exemplary method of generating customized fuel authorization commands for an enterprise controlling service station fuel pumps, according to an embodiment of the present invention. It will be appreciated that the method is programmatically performed by one or more computer-executable processes executing on, or in communication with the service station fuel pump, scanner and/or server described further below. In step 201, an initial specified pre-authorization value is received by an enterprise server. In exemplary embodiments, a user may log into a private account set up with an enterprise in order to set fuel preferences and other customized data in an account associated with the user. The customized data may include a pre-authorized specified monetary value that should be used for fuel purchases. The user may enter such data, for example, using a mobile electronic device or external computing device that is able to communicate with the enterprise server storing the user's account.

In step 203, an electronic scanning device in communication with a service station fuel pump receives identification data from an electronic device associated with the user. As discussed above, the electronic scanning device may include an IR reader, wireless access point, RFID reader, magnetic card reader, QR code reader, biometric scanner, NFC detector, Bluetooth detector, low energy Bluetooth detector, wand scanner, integrated-circuit chip reader, geolocation device, or any other suitable user-machine interface device regardless of mobility or form factor.

In step 205, the service station fuel pump transmits the identification data received from the electronic device to one or more enterprise servers. The servers then associate the identification data with the user's account in step 207 in order to retrieve an initial specified pre-authorization value. The initial specified pre-authorization value can be set by the user and stored in the user's account as described in step 201. As discussed above, the user's account may include customized data indicating a specified monetary value of fuel to be purchased by the user. In some embodiments, the user's account may also include customized data relating to the user's preferred fuel type or grade, fuel purchase history, receipt delivery options, payment preferences, payment authorization options, fuel additive or car wash intervals, vehicle service history, vehicle service schedule, vehicle service preferences, vehicle identification data, vehicle specifications, vehicle mileage, etc.

In exemplary embodiments, a user has the option to update account parameters and settings, such as the specified monetary value to be used for pre-authorizing fuel purchases. In step 209, if no new or updated specified pre-authorization value is received, a request for authorization of the specified monetary value is made in step 213. If a new pre-authorization value is received in step 209, the new value is retrieved in step 211, and a request for authorization for the new specified monetary value is requested in step 213.

In step 215, an authorization is received for the specified monetary value from a financial institution or financial account associated with the user. In step 217, a fuel authorization command is generated to initiate dispensing of fuel from the service station fuel pump for an amount of fuel that has a monetary value corresponding to the received authorization. The fuel authorization command is transmitted in step 219 to the service station fuel pump to initiate dispensing of fuel. Once the fuel has been dispensed, the purchase data is recorded in the user's account in step 221 in order to update the user's fuel purchase history.

In addition to providing customized fuel services, exemplary embodiments disclose systems, methods, and devices for receiving user identification data to initiate an automotive services work flow. In such embodiments a tag or electronic device associated with a user or a user's vehicle can be read or scanned as the user enters a parking lot or bay in order to automatically generate a work order and initiate an automotive services work flow.

In one exemplary embodiment for generating an automotive work flow, when a vehicle with a pre-scheduled appointment enters an automotive service bay or parking lot of a service center, an electronic scanning device can scan and receive identification data relating to a user or a user's vehicle. The identification data is used to programmatically initiate a work order and pre-load service preferences (oil type, tire sizes, etc.) and service recommendations (tire rotation, oil change, brake flush, transmission flush, etc.) for the automotive associate. Real-time service status updates and a copy of a work order can be emailed, pushed to a mobile device, pulled to the user's mobile device and/or stored electronically in the user's account. In such an example, a customer who has a pre-scheduled service appointment could initiate a work order by simply entering the automotive service area with the electronic device bearing the identification data. In exemplary embodiments, the service can be performed and paid for based on information contained in the user's account such that the user will not need to interact with an associate as long as no additional vehicle concerns are identified.

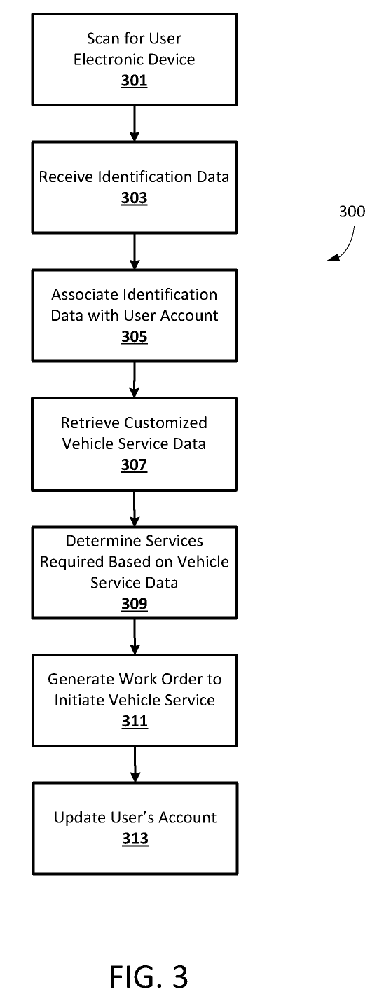

FIG. 3 is a flowchart illustrating an exemplary method of generating customized automotive work orders, according to embodiments of the present invention. It will be appreciated that the method is programmatically performed by one or more computer-executable processes executing on, or in communication with, the scanner and/or server described further below. In step 301, an electronic scanning device scans for a user electronic device, such as an RFID tag, in order to receive identification data from the electronic device. As discussed above, the electronic scanning device may include an IR reader, wireless access point, RFID reader, magnetic card reader, QR code reader, biometric scanner, NFC detector, Bluetooth detector, low energy Bluetooth detector, wand scanner, integrated-circuit chip reader, geolocation device, or any other suitable user-machine interface device regardless of mobility or form factor.

In step 303, a server in communication with the electronic scanning device receives the identification data from the electronic scanning device. In step 305, the server accesses the user's account associated with the identification data. As discussed above, the user's account may include, for example, customized data relating to the user's vehicle service history and the user's vehicle service preferences. In step 307, customized vehicle service data is retrieved from the user's account. Associating the identification data with a user's account can also pre-load the user's vehicle information into an enterprise's automotive services system so that a non-scheduled work order can be pre-populated with relevant data. This may improve the customer experience, increase sales, and assist customers who know little about their vehicles while making the service center more efficient. Tire size, oil type, brake pad size, service recommendations, etc. are all examples of additional information that could be gathered before the customer ever reaches an associate to request a work order. In exemplary embodiments, the user's payment information is saved in the user's account, allowing the user to simply leave after service is complete without the need to interact with an associate. The customized vehicle service data may also include data relating to the user's receipt delivery options, car wash preferences, fuel type, contact information, payment preferences, etc.

In step 309, the services required are determined based on the vehicle service data retrieved in step 307 which is compared against pre-determined criteria to determine which services are to be performed. In exemplary embodiments, the services may be determined based on the vehicle's service history, a service maintenance schedule for the vehicle model, make and year, or other information saved in the user's account. In step 311, a work order is generated to initiate vehicle services. Once the vehicle services have been completed, the user's account is updated in step 313 by recording the services performed on the user's vehicle in a database. During the performance of the work, the updates may occur in real-time as each is accomplished and the user may be informed electronically of the current service status.

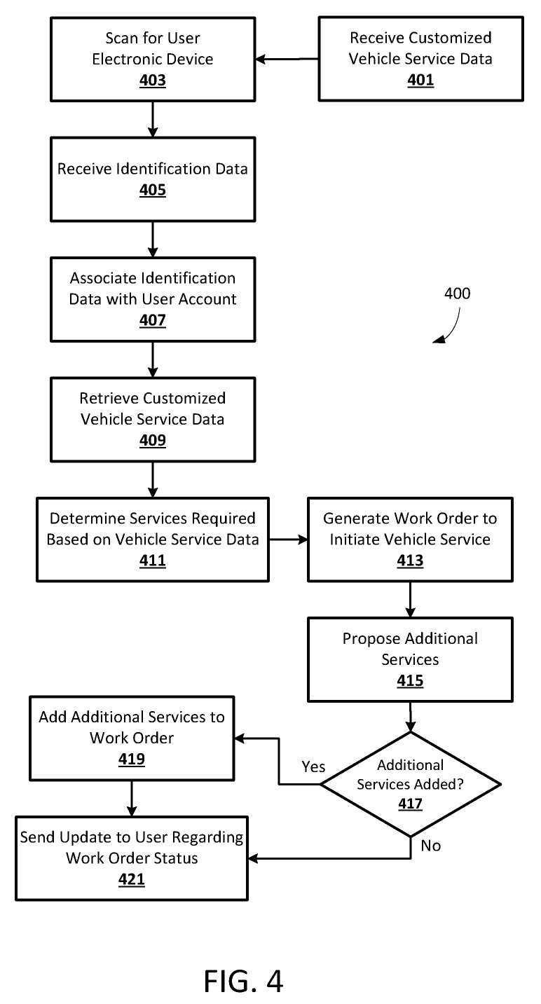

FIG. 4 is a flowchart illustrating another exemplary method of generating customized automotive work orders, according to embodiments of the present invention. In step 401, customized vehicle service data is received from a user. In exemplary embodiments, a user may log into a private account set up with an enterprise in order to schedule service appointments and set customized vehicle service data, including tire size, oil type, brake pad size, service requests, receipt delivery options, car wash preferences, fuel type, contact information, payment preferences, etc. The user may enter such data, for example, using a mobile electronic device or external computing device. In step 403, an electronic scanning device scans for a user electronic device, such as an RFID tag, in order to receive identification data from the electronic device.

In step 405, a server in communication with the electronic scanning device receives the identification data from the electronic scanning device. In step 407, the server accesses the user's account associated with the identification data. As discussed above, the user's account may include, for example, customized data relating to the user's vehicle service history and the user's vehicle service preferences. In step 409, customized vehicle service data is retrieved from the user's account. In step 411, the services required are determined based on the vehicle service data retrieved in step 409 which is compared against pre-determined criteria to determine which services are to be performed. In exemplary embodiments, the services may be determined based on the vehicle's service history, a service maintenance schedule for the vehicle model, make and year, or other information saved in the user's account. In step 413, a work order is generated to initiate vehicle services. In step 415, an associate may propose additional services that may be added to the work order or scheduled for later visits. If additional services are approved in step 417, the additional services are added to the work order in step 419. However, if no additional services are approved, the work order proceeds as generated in step 413. In step 421, an update is sent to the user regarding the status of the work order. In exemplary embodiments, push notifications or other mobile notifications can keep the user informed in real-time of the status of the work order. The user may receive periodic updates regarding the status of the work order via a mobile device, as well as a completion notification.

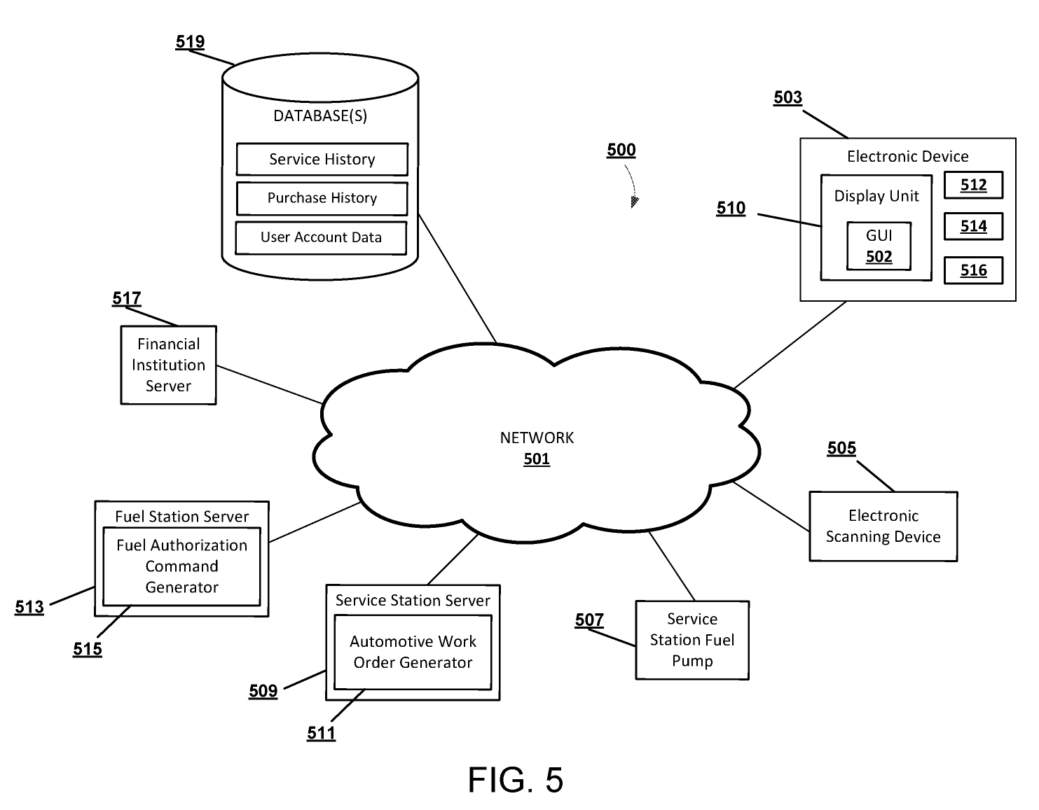

FIG. 5 illustrates a network diagram depicting a system 500 suitable for a distributed implementation of exemplary embodiments. The system 500 can include a network 501, electronic scanning device 505, service station fuel pump 507, service station server 509, fuel station server 513, financial institution server 517, database 519, and computing device 503. As will be appreciated, various distributed or centralized configurations may be implemented, and in some embodiments a single server can be used. In exemplary embodiments, the database 519 can store the vehicle service history data, purchase history data, and user account data, while the service station servers 509 and 513 can store the automotive work order generator 511, and fuel authorization command generator 515, which can implement one or more of the processes described herein with respect to FIGS. 1-4. In some examples, the service station server 509 and fuel station server 513 can communicate with the financial institution server 517 to request pre-authorization of a specified monetary value of fuel to be purchased. The service station server 509 and fuel station server 513 can also communicate directly or indirectly with the database 519 to receive user account data, fuel purchase history data, service history data, etc. The service station server 509 and fuel station server 513 can also communicate with the computing device 503 to receive updated service or fuel preferences and transmit work order status updates. The service station server 509 and fuel station server 513 can also communicate with the service station fuel pump 507 to receive identification data and transmit fuel authorization commands. In exemplary embodiments, the service station server 509 and fuel station server 513 can be local to the service station fuel pump 507 or located remotely.

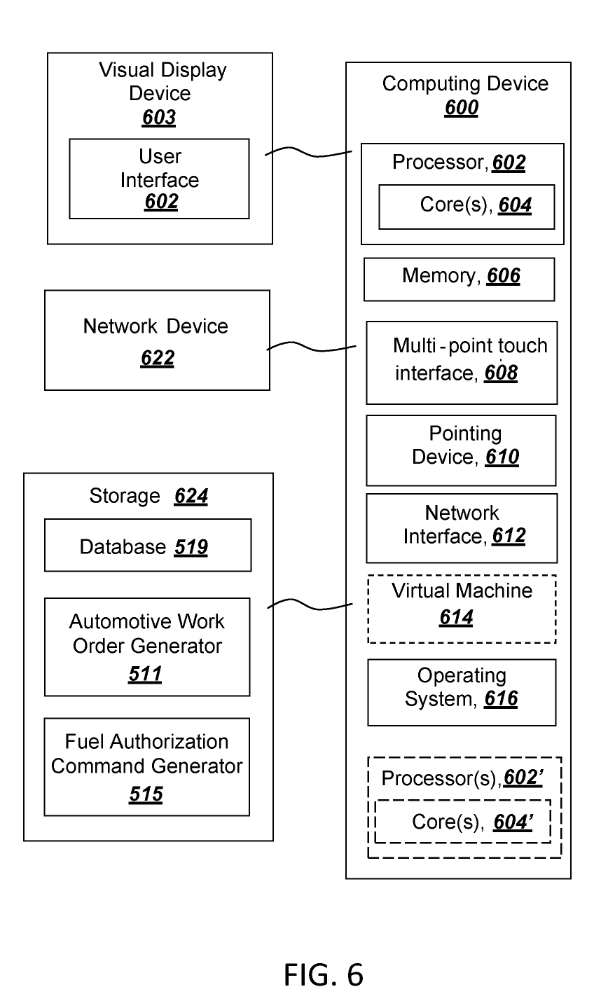

In exemplary embodiments, computing device 503 may display a GUI 502 to a user such that a user can enter fuel or automotive service preferences, as described above. In some examples, the service station server 509 and fuel station server 513 can transmit notifications regarding the status of a work order to a user via the computing device 503. The device 503 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like. The device 503 may include some or all components described in relation to visual display device 603 shown in FIG. 6.

In some embodiments, the service station fuel pump 507 is a point of sale (POS) system. In this case, the device 507 may comprise, but is not limited to, gas pumps, cash registers, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, smartphones, tablets, netbooks, and the like. The device 507, being a POS system, can be part of a store infrastructure and aid in performing various transactions related to fuel sales and other aspects of a store. Being part of a store's infrastructure, the device 507 may be installed within the store or may be installed or operational outside of the store. For example, the device 507 may be a mobile device that a store employee can use outside of the store to perform transactions or other activities. In another example, the device 507 may be a kiosk installed outside the store. Similarly, the device 507 may be a mobile device that can be used within the store, and is not physically installed or attached to one particular location within the store. The device 507 may also include various external or peripheral devices to aid in performing sales transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like. The device 507 may connect to network 501 via a wired or wireless connection. The device 507 may include one or more applications such as, but not limited to, a web browser, a sales transaction application, a card reader application, cash deposit system, and the like.

In exemplary embodiments, the servers 509, 513, and 517, database 519, service station fuel pump 507, electronic scanning device 505, and computing device 503 may be in communication with each other via a communication network 501. The communication network 501 may include, but is not limited to, the Internet, an intranet, a LAN (Local Area Network), a WAN (Wide Area Network), a MAN (Metropolitan Area Network), a wireless network, an optical network, and the like. In one embodiment, service station server 509 and fuel station server 513 can transmit instructions to the service station fuel pump 507 over the communication network 501. In exemplary embodiments, the fuel purchase history, service history, and other user account data can be stored at database 519 and received at the service station server 509 and fuel station server 513.

FIG. 6 is a block diagram of an exemplary computing device 600 that can be used in the performance of any of the example methods according to the principles described herein. The computing device 600 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 606 included in the computing device 600 can store computer-readable and computer-executable instructions or software for implementing exemplary embodiments, such as an automotive work order generator 511 and/or fuel authorization command generator 515 associated with embodiments of the present invention and programmed to perform processes described above in reference to FIGS. 1-4. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can be non-transitory computer-readable media including a computer system memory or random access memory, such as DRAM, SRAM, EDO RAM, and the like. Memory 606 can include other types of memory as well, or combinations thereof.

A user can interact with the computing device 600 through a visual display device 603, such as a touch screen display or computer monitor, which can display one or more user interfaces 604 that can be provided in accordance with exemplary embodiments. The computing device 600 can include other I/O devices for receiving input from a user, for example, a keyboard or any suitable multi-point touch interface 608, a pointing device 610 (e.g., a pen, stylus, mouse, or trackpad). The keyboard 608 and the pointing device 610 can be coupled to the visual display device 603. The computing device 600 can include other suitable conventional I/O peripherals.

The computing device 600 can also include one or more storage devices 624, such as a hard-drive, CD-ROM, or other non-transitory computer readable media, for storing data and computer-readable instructions and/or software, such as an automotive work order generator 511 and a fuel authorization command generator 515 that implement exemplary embodiments of the methods and systems as taught herein, or portions thereof. Exemplary storage device 624 can also store one or more databases 519 for storing any suitable information required to implement exemplary embodiments. The databases can be updated by a user or automatically at any suitable time to add, delete, or update one or more items in the databases. Exemplary storage device 624 can store one or more databases 519 for storing vehicle service history, fuel purchase history, customized user account data, and any other data/information used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A distributed fuel pump control system comprising:
a service station fuel pump configured to dispense fuel to a user;
an electronic scanning device in communication with the service station fuel pump and configured to receive identification data from an electronic device associated with the user; and
a server in communication with the service station fuel pump and configured to:
access an account associated with the identification data, the account including customized data indicating a specified monetary value of fuel to be purchased by the user;
request authorization of the specified monetary value;
receive authorization for the specified monetary value; and
generate a fuel authorization command to initiate dispensing of fuel from the service station fuel pump for an amount of fuel that has a monetary value corresponding to the received authorization.

2. The system of claim 1, wherein the customized data indicating the specified monetary value of fuel to be purchased is specified by the user.

3. The system of claim 1, wherein the server is further configured to monitor the user's fuel purchase history, and the customized data indicating the specified monetary value of fuel to be purchased is programmatically based on the user's fuel purchase history.

4. The system of claim 1, wherein the electronic scanning device is an RFID reader and the electronic device associated with the user is an RFID tag.

5. The system of claim 1, wherein the account including customized data further includes data corresponding to the user's vehicle mileage, service history, or service preferences, and the service station fuel pump is further configured to suggest the purchasing of automotive services based on the user's vehicle mileage, service history, or service preferences.

6. The system of claim 1, wherein the server is further configured to receive the customized data from the user via an external computing device.

7. The system of claim 1, wherein the server is further configured to record the amount of fuel dispensed in the account associated with the identification data.

8. A method of controlling a distributed fuel pump system, the method comprising:
receiving identification data from an electronic device associated with a user at an electronic scanning device in communication with a service station fuel pump;
accessing, via a server in communication with the service station fuel pump, an account associated with the identification data, the account including customized data indicating a specified monetary value of fuel to be purchased by the user;
requesting, via the server, authorization of the specified monetary value;
receiving, via the server, authorization of the specified monetary value; and
generating a fuel authorization command to initiate dispensing of fuel from the service station fuel pump for an amount of fuel that has a monetary value corresponding to the received authorization.

9. The method of claim 8, wherein the customized data indicating the specified monetary value of fuel to be purchased is specified by the user.

10. The method of claim 8, further comprising monitoring the user's fuel purchase history, wherein the customized data indicating the specified monetary value of fuel to be purchased is programmatically based on the user's fuel purchase history.

11. The method of claim 8, wherein the electronic scanning device is an RFID reader and the electronic device associated with the user is an RFID tag.

12. The method of claim 8, wherein the account including customized data further includes data corresponding to the user's vehicle mileage, service history, or service preferences; the method further comprising suggesting, via the service station fuel pump, the purchasing of automotive services based on the user's vehicle mileage, service history, or service preferences.

13. The method of claim 8, further comprising receiving the customized data from the user via an external computing device.

14. The method of claim 8, further comprising recording the amount of fuel dispensed in the account associated with the identification data.

15. A non-transitory computer readable medium storing instructions executable by a processing device, wherein execution of the instructions causes the processing device to implement a method of controlling a distributed fuel pump system, the method comprising:
receiving identification data from an electronic device associated with a user at an electronic scanning device in communication with a service station fuel pump;
accessing, via a server in communication with the service station fuel pump, an account associated with the identification data, the account including customized data indicating a specified monetary value of fuel to be purchased by the user;
requesting, via the server, authorization of the specified monetary value;
receiving, via the server, authorization of the specified monetary value; and
generating a fuel authorization command to initiate dispensing of fuel from the service station fuel pump for an amount of fuel that has a monetary value corresponding to the received authorization.

16. The medium of claim 15, wherein the customized data indicating the specified monetary value of fuel to be purchased is specified by the user.

17. The medium of claim 15, wherein execution of the instructions further causes the processing device to monitor the user's fuel purchase history, wherein the customized data indicating the specified monetary value of fuel to be purchased is programmatically based on the user's fuel purchase history.

18. The medium of claim 15, wherein the electronic scanning device is an RFID reader and the electronic device associated with the user is an RFID tag.

19. The medium of claim 15, wherein the account including customized data further includes data corresponding to the user's vehicle mileage, service history, or service preferences; and
wherein execution of the instructions further causes the processing device to suggest, via the service station fuel pump, the purchasing of automotive services based on the user's vehicle mileage, service history, or service preferences.

20. The medium of claim 15, wherein execution of the instructions further causes the processing device to receive the customized data from the user via an external computing device.
